(19) United States
(12) Patent Application Publication
(10) Pub. No.: US 2009/0033614 A1
(43) Pub. Date: Feb. 5, 2009

(54) Body scales with RGB backlit display panel

(76) Inventor: Yong Liu, Zhongshan (CN)

Correspondence Address: ALIX YALE & RISTAS LLP, 750 MAIN STREET, SUITE 1400, HARTFORD, CT, 06103, US

(21) Appl. No.: 11/888,697

(22) Filed: Aug. 2, 2007

(51) Int. Cl. G09G 3/36

(52) U.S. Cl. 345/102

(57) ABSTRACT

Body scales include an LCD display panel for displaying information such as body weight and body fat of a user standing upon the scales, and LED backlighting behind the display panel having variable multicoloured output dependent upon reference meanings of that information.

### BACKGROUND OF THE INVENTION

The present invention relates to body scales. More particularly, although not exclusively, the invention relates to body scales for measuring body weight, body fat, body hydration, bone mass, muscle mass etc, such scales having an LCD display with a coloured backlighting feature.

Known body scales comprise a platform having a number of conductive pads upon which a user stands. A small current passes through the body via the pads and an estimated body fat reading is displayed upon an LCD display panel situated forward of the pads. The LCD panels display a significant amount of information including body weight, body fat estimates, gender indication, age etc. and can be difficult to read and interpret quickly, especially under poor lighting conditions. Some manufacturers have incorporated simple backlighting into the LCD displays for improving readability in poor lighting conditions, but such backlighting provides no other useful information.

### OBJECTS OF THE INVENTION

It is an object of the present invention to overcome or substantially ameliorate at least one of the above disadvantages and/or more generally to provide an improved set of body scales having a backlit LCD display panel in which a number of coloured backlighting effects are provided with different colours indicating different information.

### DISCLOSURE OF THE INVENTION

There is disclosed herein body scales comprising an LCD display panel for displaying information such as body weight and body fat of a user standing upon the scales, and LED backlighting behind the display panel having variable multicoloured output dependent upon reference meanings of said information.

Preferably, said LED backlighting comprises a light-transmissive panel and one or more LEDs illuminating the panel.

Preferably, each LED comprises internal R, G and B emission diode circuitry.

### BRIEF DESCRIPTION OF THE DRAWINGS

A preferred form of the present invention will now be described by way of example with reference to the accompanying drawings, wherein:

FIG. 1 is a schematic plan view of a set of body scales,

FIG. 2 is a schematic plan view of an LCD display panel of the body scales,

FIG. 3 is a schematic plan view of a backlight panel for the LCD display panel,

FIG. 4 is a schematic circuit diagram of a pair of multi-coloured LEDs for the backlight panel of FIG. 3,

FIG. 5 is a schematic plan view of the display panel,

FIG. 6 is a schematic cross-sectional elevation of the display panel,

FIG. 7 is a schematic circuit diagram associated with one of the multi-coloured LEDs, and

FIG. 8 is a detailed overall circuit schematic of the body scales.

### DESCRIPTION OF THE PREFERRED EMBODIMENT

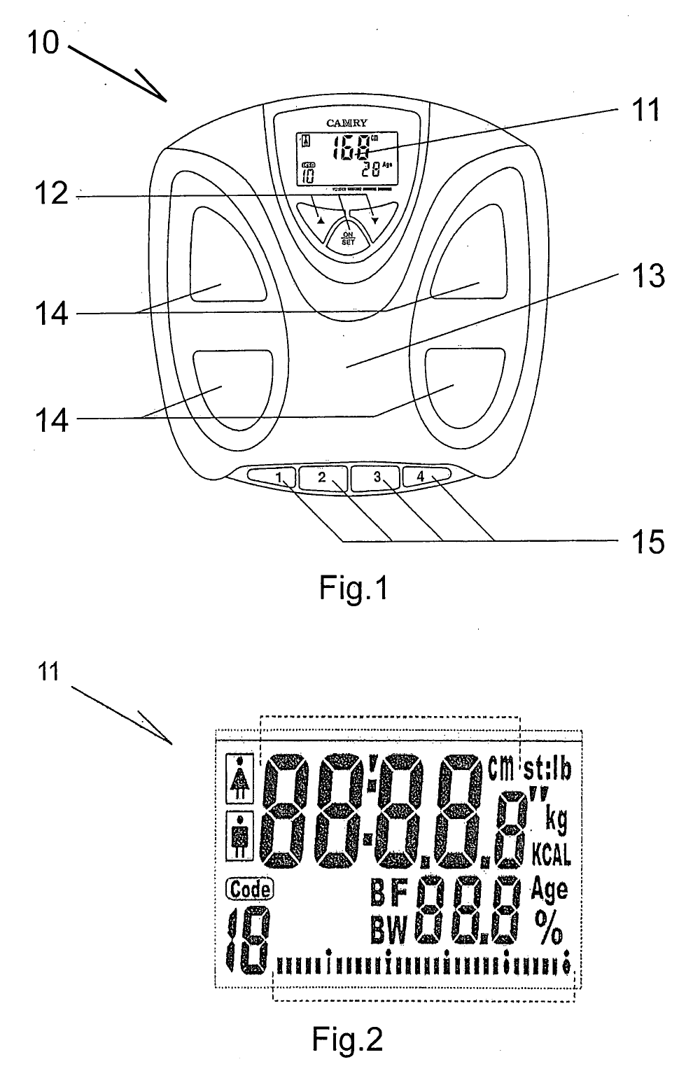

In FIG. 1 of the accompanying drawings there is depicted schematically a set of body scales 10 comprising a weight-bearing platform 13 having from one to four electrical contact pads 14 upon which the bare heels and soles of a user's feet rest in use. A display panel 11 is situated forward of the pads 14 and a number of control keys 15 are provided aft of the pads 14. The display panel 11 shows alphanumerical and graphic information typical of that of other known body scales on the market.

The LCD panel 11 as shown in FIG. 6 is mounted within a plastics frame 20 with a light transmissive backlight panel 19 situated immediately behind it. Mounted behind the backlight panel 19 is a printed circuit board (PCB) 18 held in place to the frame 20 by screws 21. A light transmissive compound 22 extends from the PCB 18 to the backlight panel 19. A pair of LEDs 16a and 16b is mounted upon the PCB and shine into the light transmissive compound 22 such that light emitted by the LEDs is conveyed to the backlight panel 19.

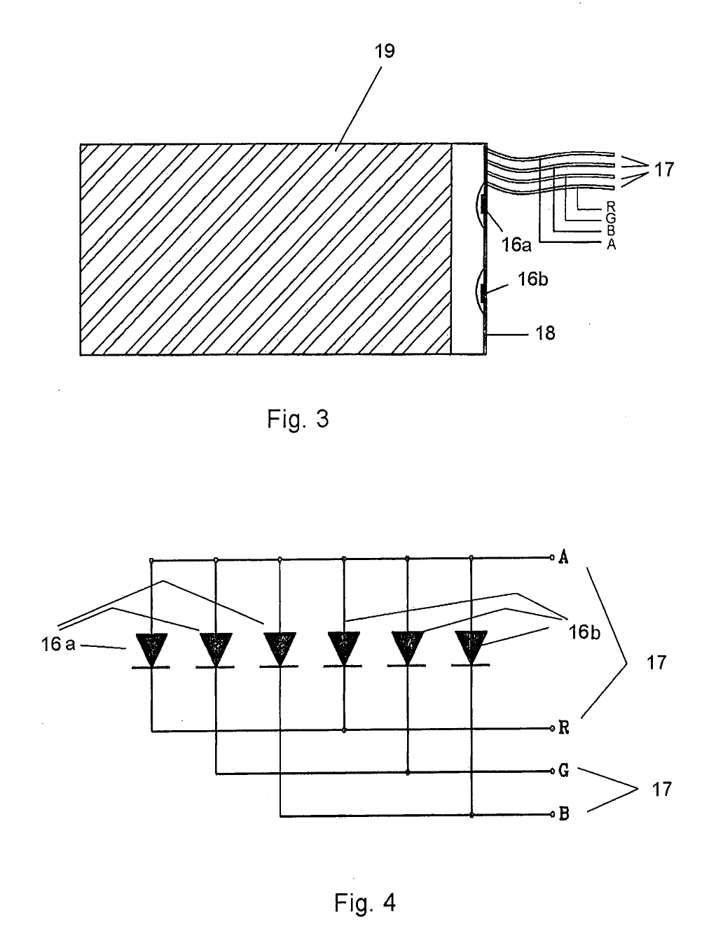

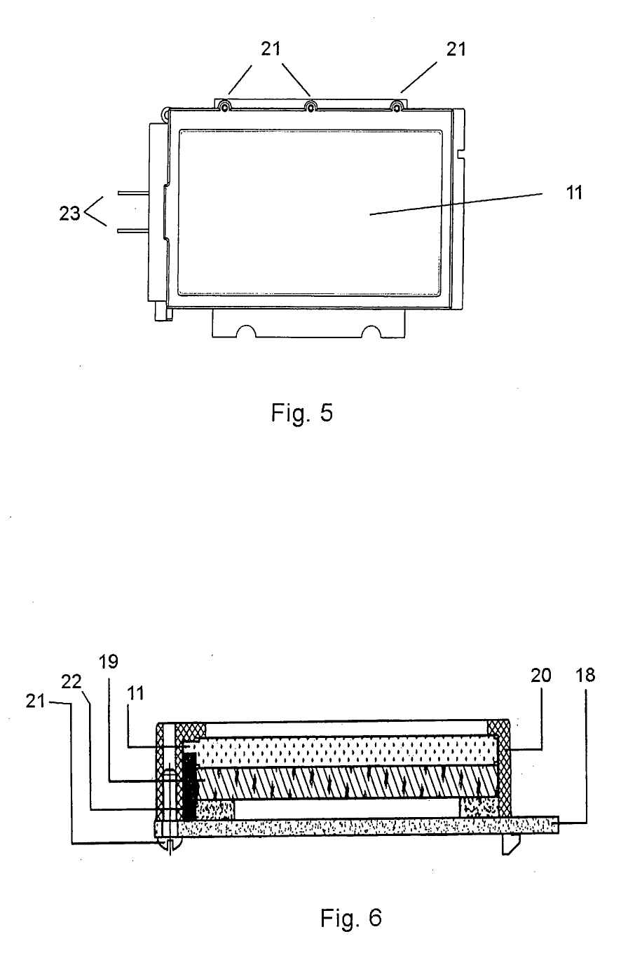

The LEDs 16a and 16b are shown in FIG. 3 upon PCB 18. Four conductors 17 feed the PCB 18. One of these is a common anode A, whereas others are for red, green and blue (RGB) LED activation. Each LED 16a and 16b is multicoloured in operation. As shown in FIG. 4, LED 16a comprises three internal diodes as does LED 16b. The anode of each diode is connected to anode rail A, whereas the individual internal RGB diodes are connected to the RGB rails respectively.

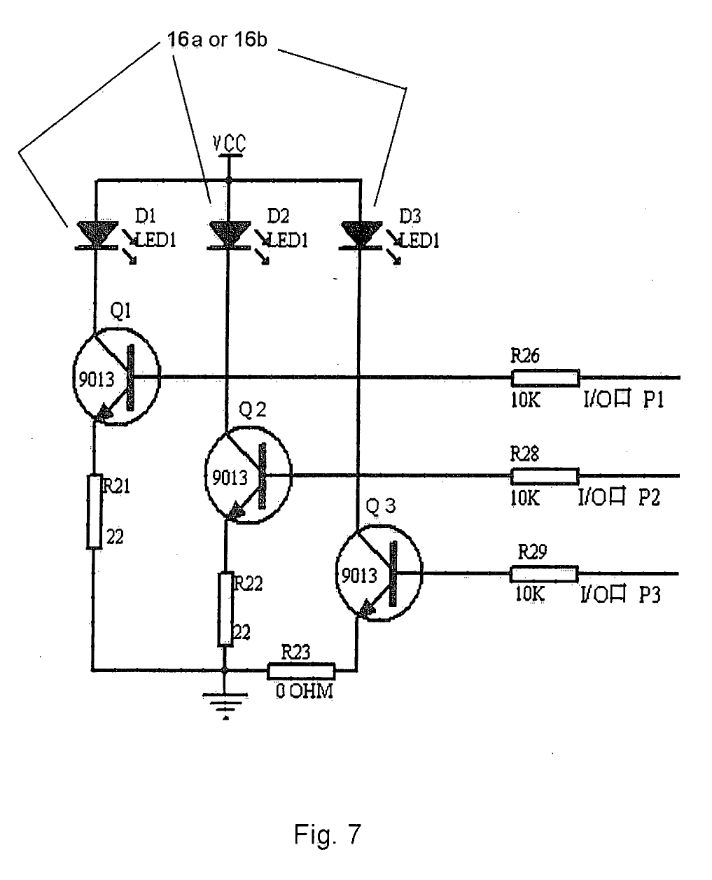

FIG. 7 shows the circuitry directly associated with one of the multi-coloured LEDs 16a or 16b. Moreover, this figure depicts a single LED package. Diode D1 emitted red light. Diode D2 emits green light. Diode D3 emits blue light. D1 is controlled by transistor Q1, resistor R21 and resistor R26. D2 is controlled by transistor Q2, resistor R22 and resistor R28. D3 is controlled by transistor Q3, resistor R23 and resistor R29. Resistors R21, R22 and R23 are connected to ground, whereas resistors R26, R28 and R29 are fed with control inputs P1, P2 and P3 respectively.

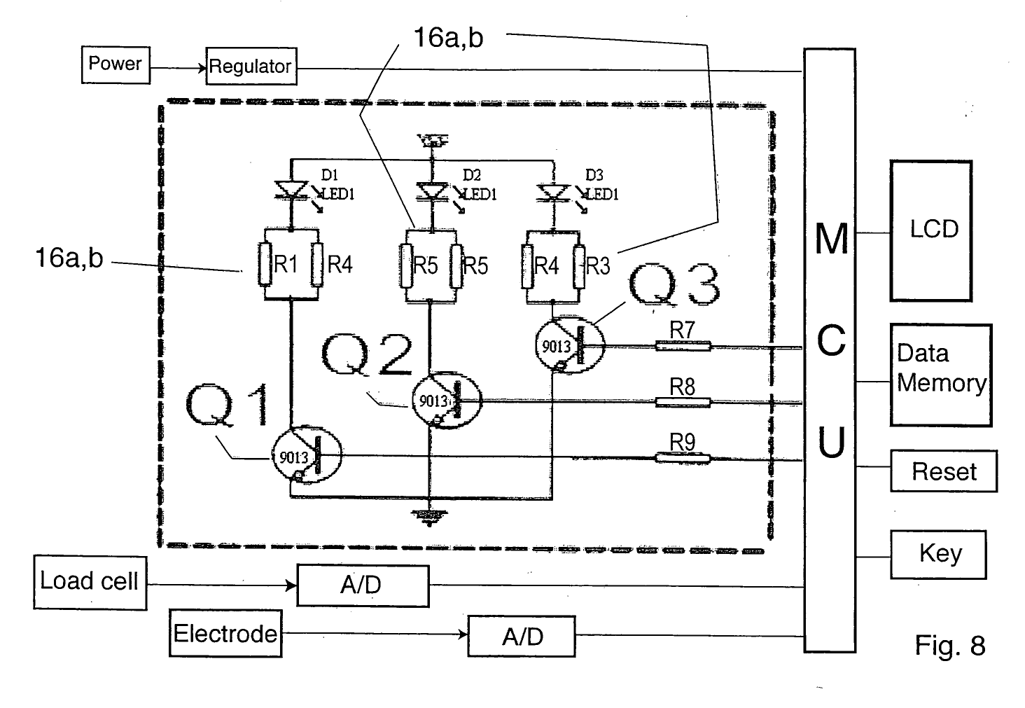

The components shown in FIG. 7 form part of the overall circuit diagram of FIG. 8 where it can be seen that the output of the micro-control unit MCU feeds inputs P1, P2, and P3.

The MCU provides output to the LCD panel 11 as well as switching control for transistors Q1, Q2 and Q3 so that each LED 16a and 16b can emit multiple combinations of red, green and blue light to thereby emitted one or more simultaneous wavelengths into the backlighting panel 19. For example, if both Q1 and Q3 are switched to ON and Q2 is switched to OFF, a purple illumination effect will be achieved. The level of brightness emitted by each LED is determined by the values chosen for R21, R22 and R23.

The circuitry can be programmed to provide say a red backlighting effect for excessively high body fat readings and say a blue backlighting effect for excessively lower body fat readings.

It should be appreciated that modifications and alterations obvious to those skilled in the art are not to be considered as beyond the scope of the present Utility Model. For example, instead of providing a pair of the LEDs at one end of the backlighting panel 19, one or more LEDs might be provided at respective opposite ends of the panel for a more even lighting effect.

1. Body scales comprising an LCD display panel for displaying information such as body weight and body fat of a user standing upon the scales, and LED backlighting behind the display panel having variable multicoloured output dependent upon reference meanings of said information.

2. The scales of claim 1, wherein said LED backlighting comprises a light-transmissive panel and one or more LEDs illuminating the panel.

3. The scales of claim 2, wherein each LED comprises internal R, G and B emission diode circuitry.
